(19) United States
(12) Patent Application Publication
(10) Pub. No.: US 2006/0034306 A1
(43) Pub. Date: Feb. 16, 2006

(54) Method for transferring a queue position

(75) Inventors: Frank-Uwe Andersen, Berlin (DE); Hermann De Meer, Passau (DE); Ivan Dedinksi, Passau (DE); Toblas Hossfeld, Wurzburg (DE); Cornella Kappler, Berlin (DE); Andreas Maeder, Wurzburg (DE); Jens Oliver Oberender, Paussau (DE); Phuoc Tran-Gia, Wurzburg (DE); Kurt Tutschku, Gerbrunn (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/117,735

(22) Filed: Apr. 29, 2005

(30) Foreign Application Priority Data
Apr. 30, 2004 (DE) 10 2004 023 653.4

(51) Int. Cl. H04L 12/56

(52) U.S. Cl. 370/412

(57) ABSTRACT

A method for transferring a queue position for a peer communication terminal is provided. This method involves a first peer communication terminal receiving a request message from a second peer communication terminal, the request message being used to request connection setup between the first and second peer communication terminals for retrieval of a file. The second peer communication terminal is then put into a file-retrieval queue on the first peer communication terminal. The first peer communication terminal sends an information message to the second peer communication terminal as soon as the second peer communication terminal has reached a predetermined position in the queue. The transmission of the information message is terminated by a proxy node before the information message reaches the second peer communication terminal. The proxy node transfers the predetermined position in the queue to a third peer communication terminal.

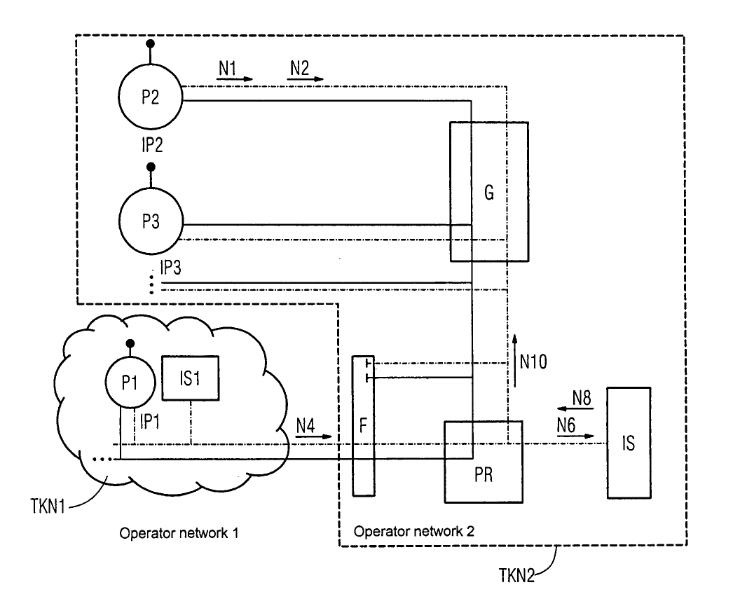

### CLAIM FOR PRIORITY

This application claims priority to German Application No. 10 2004 023 653.4, filed Apr. 30, 2004, which is incorporated herein, in its entirety, by reference.

### TECHNICAL FIELD OF THE INVENTION

The invention relates to a method for transferring a queue position for a peer communication terminal.

### BACKGROUND OF THE INVENTION

Peer-to-peer data transmissions, in which peer communication terminals (often simply called “peers”) are connected to one another via a telecommunication network, are generally known. The peer communication terminals can each perform the functions of either server or client during peer-to-peer data transmission. By way of example, a peer communication terminal can provide files (e.g. music files) for other peer communication terminals and can also retrieve them therefrom. The peer communication terminals can thus provide services for other peer communication terminals and can also retrieve services from other peer communication terminals. In this context, the peer communication terminals have equal authority among one another. The peer-to-peer data transmission between peer communication terminals differs from the data transmission between client and server computers in client/server communication networks. In the case of client/server data transmission, a communication terminal operates either as a server (which provides a service for another communication terminal) or as a client (which retrieves a service from a server) . In the case of peer-to-peer data transmission, data is held locally in various peer communication terminals and is transmitted therebetween.

Peer-to-peer data transmissions today give rise to a considerable proportion of the data transmission volume which arises in telecommunication networks. It is estimated that between 50 and 80% of the data volume transmitted via the Internet comes from peer-to-peer data transmissions.

Special network nodes (“index servers” or “file index servers”) store information about which peer communication terminals hold particular data or files. When a peer communication terminal wishes to obtain a file, for example, this peer communication terminal asks the index server for the address of a further peer communication terminal, on which the desired file is held. The peer communication terminal then retrieves the file directly from the further peer communication terminal.

Often, a peer communication terminal providing files cannot meet file retrieval requests relating to these files immediately because a plurality of peer communication terminals want to retrieve files from this peer communication terminal simultaneously. In this case, a queue is formed on the file-providing peer communication terminal. When a file-retrieving peer communication terminal retrieves a file from the file-providing peer communication terminal, the file-retrieving peer communication terminal is put into the last position in the queue. This peer communication terminal has to wait until the peer communication terminals which are ahead of it in the queue have ended their respective file retrievals. The peer communication terminal which is at the last position in the queue then moves toward the first position in the queue in steps.

### SUMMARY OF THE INVENTION

The invention is directed to specifying a flexible method for processing queues on peer communication terminals.

A method for transferring a queue position for a peer communication terminal is provided. The method involves a first peer communication terminal receiving a request message from a second peer communication terminal, the request message being used to request connection setup between the first and second peer communication terminals for retrieval of a file. The second peer communication terminal is then put into a file-retrieval queue on the first peer communication terminal. The first peer communication terminal sends an information message to the second peer communication terminal as soon as the second peer communication terminal has reached a predetermined position in the queue. The transmission of the information message is terminated by a proxy node before the information message reaches the second peer communication terminal. The proxy node transfers the predetermined position in the queue to a third peer communication terminal. A particular advantage in this context is that a queue position which has been reached by the second peer communication terminal can be transferred to the third peer communication terminal. The third peer communication terminal therefore advantageously does not have to wait until it has moved to the predetermined position in the queue, but rather the third peer communication terminal can use the queue position which has already been reached by the second peer communication terminal. The position in the queue is transferred by a proxy node in a telecommunication network which connects the first peer communication terminal and the second peer communication terminal. This proxy node can stipulate the order of file retrievals by various file-retrieving peer communication terminals.

According to an aspect of the invention, the predetermined position in the queue which is used may be the first position in the queue. The first position in the queue is that position which, when reached, allows a peer communication terminal to start retrieving the file in question. If the first position in the queue is transferred to the third peer communication terminal, then the third peer communication terminal can immediately start to retrieve the file which it requires.

The inventive method may proceed in a manner such that the proxy node receives an identification for the third peer communication terminal from an index server (which manages identifications for peer communication terminals), and the proxy node then transfers the predetermined position in the queue to the third peer communication terminal. In this context, the index server may advantageously stipulate which of the peer communication terminals can participate in the method as third peer communication terminal. By evaluating the files on offer and file retrieval requests which are available, the index server can establish whether there is a file retrieval request or a request message from a peer communication terminal which is to receive preferential treatment. If there is such a request message or such a file retrieval request, the index server transmits the identification of this peer communication terminal (which is then involved in the method as third peer communication terminal) to the proxy node.

The inventive method may also proceed in a manner such that the proxy node sends a query message to an index server asking the index server whether the predetermined position in the queue is to be used for a further peer communication terminal, the proxy node then receives an identification for the third peer communication terminal from the index server, and the proxy node transfers the predetermined position in the queue to the third peer communication terminal. In this context, the query message is advantageously used to inform the index server that the second peer communication terminal has reached the predetermined position in the queue. In addition, this query message is used to prompt the index server to ascertain whether the predetermined position is to be used for a further peer communication terminal. This further peer communication terminal may be, by way of example, a peer communication terminal belonging to a “premium user”, whose agreement provides for his file retrieval requests to be met preferentially.

According to another aspect of the invention, the proxy node uses the query message additionally to send the index server a list of the files which the first peer communication terminal provides for retrieval, and if a file retrieval request which is to be handled with priority has been received from the third peer communication terminal, and the file retrieval request relates to one of the files provided, then the index server sends the proxy node the identification of the third peer communication terminal. From the list, the index server may advantageously identify whether the file retrieval request from the third peer communication terminal can actually be met by the first peer communication terminal. If this is the case, the identification of the third peer communication terminal is sent to the proxy node. If this is not the case, an identification for a peer communication terminal is sent to the proxy node, and for this peer communication terminal a file retrieval request matches the file provided by the first peer communication terminal.

The inventive method may proceed in a manner such that the proxy node informs the third peer communication terminal that it has reached the predetermined position in the queue. This informs the third peer communication terminal that it has “moved forward” in the queue.

The method according to an embodiment of the invention may be in a form such that the proxy node transfers the queue position which was originally occupied by the third peer communication terminal to the second peer communication terminal. This means that the second peer communication terminal does not need to be put into the last position in the queue, but rather the second peer communication terminal can adopt the queue position which was originally occupied by the third peer communication terminal.

The method may proceed in a manner such that the proxy node transfers the predetermined position in the queue to the third peer communication terminal by virtue of the proxy node switching a communication channel which connects the first peer communication terminal to the second peer communication terminal such that this communication channel connects the first peer communication terminal to the third peer communication terminal. This allows the predetermined position to be transferred to the third peer communication terminal quickly and easily.

The method allows the proxy node to transmit the information message to the third peer communication terminal via the switched communication channel. For this purpose, the proxy node can buffer-store the information message whose transmission it has terminated.

### BRIEF DESCRIPTION OF THE DRAWINGS

To explain the invention further, the FIGURE is used to explain an exemplary embodiment of a cycle of the inventive method.

### DETAILED DESCRIPTION OF THE INVENTION

The bottom left-hand part of the FIGURE schematically shows a first telecommunication network TKN1 in the form of a peer-to-peer landline network (P2P landline network, fixed P2P network). Installed in this first telecommunication network TKN1 are a stationary first peer communication terminal P1 (fixed-location peer communication terminal, fixed peer) and further stationary peer communication terminals (not shown). The first peer communication terminal P1 is a computer connected to the first telecommunication network TKN1 by a data line, for example. The first peer communication terminal P1 has an associated address in the form of a first Internet address IP1. The first telecommunication network TKN1 contains a first index server IS1. The first telecommunication network TKN1 may be a telephone landline network or else the Internet, for example.

The first telecommunication network TKN1 is a first operator network (operator network 1, first operator domain) belonging to a first network operator; the first telecommunication network is thus under the control of the first network operator. The first network operator can transmit data within the first operator network at the cost-of-sale price, i.e. the first network operator does not need to make any payments to other network operators for such transmission of data.

The FIGURE also shows a second mobile peer communication terminal P2 (mobile peer) and a third mobile peer communication terminal P3. The mobile peer communication terminals P2 and P3 may be, by way of example, mobile telephones or computers or personal digital assistants (PDA) with a mobile radio interface. The mobile peer communication terminals P2 and P3 are associated with a second telecommunication network TKN2, which is a mobile radio network in the exemplary embodiment. From the second telecommunication network TKN2, the FIGURE shows only a gateway G (in the form of a gateway GPRS Support Node, GGSN), a proxy node PR (peer-to-peer proxy, P2P Proxy), an index server IS and a firewall F. Further elements of the mobile radio network TKN2, such as base stations and switching centers, have been omitted in the FIGURE for the sake of clarity. The second peer communication terminal P2 has an associated address in the form of a second Internet address IP2; the third peer communication terminal P3 has an associated address in the form of a third Internet address IP3.

The second telecommunication network TKN2 is under the control of a second telecommunication network operator; the second telecommunication network TKN2 is thus a second operator network (operator network 2, second operator domain). The network operator of the second telecommunication network can transmit data within the second communication network at the cost-of-sale price, i.e. the network operator of the second telecommunication network does not need to make any payments to other network operators for such transmission of data.

The mobile peer communication terminals P2 and P3 are connected to the proxy node PR via the gateway. The user data interchange (file exchange) between the second mobile peer communication terminal P2 and the stationary peer communication terminal P1 and between the third mobile peer communication terminal P3 and the stationary peer communication terminal P1 is symbolized by solid lines in the FIGURE. The peer communication terminals, the gateway, the first index server IS1, the second index server IS and the proxy node exchange signaling messages. The data transmission channel for these signaling messages is symbolized by a dash-dot line in the FIGURE.

The text below describes an exemplary embodiment of the inventive method. The second peer communication terminal P2 needs to participate in a peer-to-peer data transmission during which the second peer communication terminal P2 needs to download a file from the file-providing first peer communication terminal P1 (file download).

The second peer communication terminal P2 sends a request message N1 to the first peer communication terminal P1. The request message N1 is transmitted to the first peer communication terminal P1 via the gateway G and the proxy node PR. (Direct transmission of the request message N1 to the first peer communication terminal P1 bypassing the proxy node PR is not possible, since such transmission would be prevented by the firewall F). The request message N1 is used to request connection setup between the first peer communication terminal P1 and the second peer communication terminal P2. If the first and second peer communication terminals are peer communication terminals which communicate on the basis of “E-Donkey” stipulations (that is to say are “E-Donkey peers or peer communication terminals running an application based on the E-Donkey protocol), the request message N1 transmitted may be an “E-Donkey” message “connection establishment”.

If other peer communication terminals have already sent request messages to the first peer communication terminal P1 at a time prior to the second peer communication terminal, the first peer communication terminal P1 cannot transmit the file which the second peer communication terminal has requested to the second peer communication terminal P2 immediately. The second peer communication terminal P2 is therefore put into a file-retrieval queue on the first peer communication terminal P1; the second peer communication terminal is allocated the last position in this queue.

Having been put into the queue, the second peer communication terminal P2 periodically sends acknowledgement messages N2 (“keep-alive messages”) to the first peer communication terminal P1. In the absence of these acknowledgement messages, the first peer communication terminal recognizes that the second peer communication terminal is no longer interested in retrieving the file, for example because the second peer communication terminal P2 has been switched off. The first peer communication terminal P1 periodically sends messages to the second peer communication terminal P2; these messages are used to inform the second peer communication terminal P2 about the respective position reached in the queue.

When the peer communication terminals which are ahead of the second peer communication terminal in the queue have successfully downloaded their respective retrieved file, the second peer communication terminal P2 moves to the positions ahead in the queue in steps. As soon as the second peer communication terminal has reached a predetermined position in the queue, the first peer communication terminal P1 sends an information message N4 to the second peer communication terminal. In the exemplary embodiment, it is assumed that the predetermined position in the queue is the first position in the queue. In other exemplary embodiments, however, any other positions in the queue may also be predetermined (for example the second, fifth or tenth position).

The information message N4 is routed from the first peer communication terminal P1 via the firewall F to the proxy node PR. The proxy node PR terminates the transmission of the information message N4 and buffer-stores this information message N4. As a result, the information message N4 does not reach the second peer communication terminal P2. When the information message N4 has been received, the proxy node PR sends a query message N6 to the index server IS in the second telecommunication network TKN2. The index server IS manages file requests from peer communication terminals, for example, and identifications (e.g. addresses) of peer communication terminals which provide files for download. The proxy node PR uses this query message N6 to ask the index server IS whether the (first) queue position reached by the second peer communication terminal P2 is to be used for another peer communication terminal. The index server IS checks whether it has information about a further peer communication terminal which has likewise used its own request message to request retrieval of a file from the first peer communication terminal P1. In the exemplary embodiment, the index server IS has the information that the third peer communication terminal P3 has requested retrieval of a file which is held on the first peer communication terminal P1. In addition, the index server IS has the information that this file retrieval request from the third peer communication terminal P3 is to be given preferential treatment, since the third peer communication terminal P3 is registered as a “premium peer communication terminal” which is to receive preferential treatment for file retrieval requests. The index server IS then uses a message N8 to transmit an identification for the third peer communication terminal in the form of the Internet address IP3 to the proxy node PR. The proxy node PR then transfers the first position in the queue from the second peer communication terminal P2 to the third peer communication terminal P3.

In the exemplary embodiment described above for the inventive method, the index server IS already stored the information regarding which files the first peer communication terminal P1 provides for retrieval. In an alternative exemplary embodiment, it is additionally or optionally possible to use the query message N6 for additionally transmitting a list of the files which the first peer communication terminal P1 provides for retrieval to the index server IS. The index server IS can then use the received list to check whether the file retrieval request from the third peer communication terminal P3 (which request is to be given preferential treatment) actually relates to one of the files which the first peer communication terminal provides. Only if the file requested by the third peer communication terminal P3 is actually provided by the first peer communication terminal P1 is the identification IP3 of the third peer communication terminal P3 sent to the proxy node PR using the message N8.

The predetermined position in the queue is transferred to the third peer communication terminal in the following manner: the proxy node has a “SOCKS” functionality, where “SOCKS” is an abbreviation for “sockets”. This functionality is known from the printed document RFC 1928/1929 from the IETF. The peer communication terminals P1, P2 and P3 are configured such that they use the proxy node PR, i.e. that they transmit their messages via the proxy node PR. To transmit information, the proxy node PR sets up a communication channel between the peer communication terminals, for example between the first peer communication terminal P1 and the second peer communication terminal P2. Such a communication channel is set up from the first peer communication terminal P1 via the firewall F to a first port at the proxy node PR. The proxy node PR connects this communication channel to the second peer communication terminal P2 via the gateway G using a second port. Similarly, the proxy node PR sets up a second communication channel between the first peer communication terminal P1 and the third peer communication terminal P3. To transfer the predetermined position in the queue from the second peer communication terminal P2 to the third peer communication terminal P3, the proxy node PR switches the first communication channel (previously connecting the first peer communication terminal P1 to the second peer communication terminal P2) over such that this first communication channel connects the first peer communication terminal Pi to the third peer communication terminal P3. In this case, communication channel terminal points within the proxy node, which are known as “sockets”, are connected together afresh. At the same time, the second communication channel (which previously connected the first peer communication terminal P1 to the third peer communication terminal P3) is switched over so that this second communication channel now connects the first peer communication terminal P1 to the second peer communication terminal P2. The first communication channel which has been switched over is now used by the proxy node PR to send the previously buffer-stored information message N4 to the third peer communication terminal. The third peer communication terminal interprets the information message as meaning that it has reached the first position in the queue. This means that the predetermined (i.e. the first) position in the queue has been transferred to the third peer communication terminal.

Additionally or alternatively, the proxy node PR may transmit a further message N10 to the third peer communication terminal, informing the third peer communication terminal that the predetermined position in the queue has been reached.

The third peer communication terminal P3 then sends the first peer communication terminal P1 an identifier for a file which it wishes to retrieve from the first peer communication terminal P1. This identifier may be the name of the file, for example, or a value clearly describing the file (a “content hash” or “direct link”). (Optionally, one or more search terms may be sent to the index server IS by the third peer communication terminal P3 beforehand; the index server IS then searches for files matching the search terms and, if the search is successful, sends a list containing the file names of the matching files to the third peer communication terminal P3.)

The first peer communication terminal P1 then transmits the file (or segments of the file in the form of “chunks”) to the third peer communication terminal P3 via the proxy node PR. Within the context of this application, the term “file” is understood to mean not just a complete file but also file segments (chunks), which can be retrieved by the file-retrieving peer communication terminals P2 and P3.

The second peer communication terminal P2, which is now in a position toward the back of the queue, periodically sends acknowledgement messages (similar to the acknowledgement messages N2 cited above) to the first peer communication terminal P1 and is moved toward the front positions in the queue in steps. At this juncture, it should be pointed out that the second peer communication terminal is naturally not physically put into the queue, but rather the queue merely stores information regarding the order in which the file retrievals are to be handled.

The method described may be used in the following situation, in particular: besides the second peer communication terminal P2, other peer communication terminals (not shown in the FIGURE) have also requested retrieval of one and the same file from the first peer communication terminal P1. Using the method described, however, the requested file is transmitted not to the second peer communication terminal but rather to the third peer communication terminal P3. The third peer communication terminal P3 is (in a departure from the illustration in the FIGURE) a peer communication terminal which is permanently installed in a stationary part of the mobile radio network TKN2 (landline part of the mobile radio network, e.g. in the packet switched domain of 2.5/3 G telecommunication networks) as a landline peer. This landline peer is connected to the proxy node PR by high-power data transmission lines. As soon as the file is in this landline peer communication terminal completely, the file is transmitted via the proxy node PR to the second peer communication terminal P2 and to the other mobile peer communication terminals (not shown) which are likewise retrieving this file. Assuming that the data transmission from the landline peer communication terminal (which is arranged in the landline part of the mobile radio network TKN2) to the proxy node PR takes place more quickly and in more stable fashion than the data transmission from the first peer communication terminal P1 to the proxy node PR, this allows a significant speed advantage to be achieved when transmitting the file.

The method described advantageously allows inflexible processing of the queue to be avoided. Selected peer communication terminals can be given preferential treatment over other peer communication terminals by virtue of these peer communication terminals which are to be given preferential treatment adopting a (front) queue position from another peer communication terminal. The other peer communication terminal (in the exemplary embodiment of the second peer communication terminal P2) receives the (less favorable, i.e. back end) queue position transferred from the peer communication terminal which is to be given preferential treatment.

What is claimed is:

1. A method for transferring a queue position for a peer communication terminal, comprising:
receiving, at a first peer communication terminal, a request message from a second peer communication terminal, the request message being used to request a connection setup between the first and second peer communication terminals for retrieval of a file;
putting the second peer communication terminal into a file-retrieval queue on the first peer communication terminal;
sending an information message from the first peer communication terminal to the second peer communication terminal as soon as the second peer communication terminal has reached a predetermined position in the queue;
terminating transmission of the information message by a proxy node before the information message reaches the second peer communication terminal; and
transferring the predetermined position in the queue from the proxy node to a third peer communication terminal.

2. The method as claimed in claim 1, wherein the predetermined position in the queue is a first position in the queue.

3. The method as claimed in claim 1, wherein
the proxy node receives an identification for the third peer communication terminal from an index server, and
the proxy node then transfers the predetermined position in the queue to the third peer communication terminal.

4. The method as claimed in claim 1, wherein
the proxy node sends a query message to an index server asking the index server whether the predetermined position in the queue is to be used for a further peer communication terminal,
the proxy node then receives an identification for the third peer communication terminal from the index server, and
the proxy node transfers the predetermined position in the queue to the third peer communication terminal.

5. The method as claimed in claim 4, wherein
the proxy node uses the query message additionally to send the index server a list of the files which the first peer communication terminal provides for retrieval,
if a file retrieval request which is to be handled with priority has been received from the third peer communication terminal, and the file retrieval request relates to one of the files provided, then the index server sends the proxy node the identification of the third peer communication terminal.

6. The method as claimed in claim 1, wherein the proxy node informs the third peer communication terminal that it has reached the predetermined position in the queue.

7. The method as claimed in claim 1, wherein the proxy node transfers the queue position which was originally occupied by the third peer communication terminal to the second peer communication terminal.

8. The method as claimed in claim 1, wherein
the proxy node transfers the predetermined position in the queue to the third peer communication terminal by virtue of the proxy node switching a communication channel which connects the first peer communication terminal to the second peer communication terminal such that this communication channel connects the first peer communication terminal to the third peer communication terminal.

9. The method as claimed in claim 8, wherein the proxy node transmits the information message to the third peer communication terminal via the switched communication channel.
